(19) United States
(12) Patent Application Publication
(10) Pub. No.: US 2024/0220203 A1
(43) Pub. Date: Jul. 4, 2024

(54) STREAMING-BASED COMPUTE UNIT AND METHOD, AND ARTIFICIAL INTELLIGENCE CHIP

(71) Applicant: Shenzhen Corerain Technologies Co., Ltd., Shenzhen (CN)

(72) Inventors: Li JIAO, Shenzhen (CN); Kuen Hung Tsoi, Shenzhen (CN); Xinyu Niu, Shenzhen (CN)

(73) Assignee: Shenzhen Corerain Technologies Co., Ltd., Shenzhen (CN)

(21) Appl. No.: 18/362,188

(22) Filed: Jul. 31, 2023

(30) Foreign Application Priority Data
Jan. 4, 2023 (CN) 2023100067180

(51) Int. Cl. G06F 7/544; G06F 7/50; G06F 7/523

(52) U.S. Cl. CPC G06F 7/5443; G06F 7/50; G06F 7/523

(57) ABSTRACT

A streaming-based compute unit and method, and an artificial intelligence chip, relating to artificial intelligence field. The compute unit includes N registers configured to perform N convolutions on N convolution windows and a convolution kernel. A j^{th} convolution includes performing M multiplications on M data in a j^{th} convolution window and M data in the convolution kernel, to obtain M first computation results. The N convolutions include N multiplications sequentially and consecutively performed on at least one set of feature map data and convolution kernel data. Each feature map data set includes N data from N convolution windows at the same position. A j^{th} register is configured to store a second computation result of the j^{th} convolution window. After an i^{th} multiplication in the j^{th} convolution, the second computation result is updated into a sum of i first computation results in the j^{th} convolution.

### TECHNICAL FIELD

The present disclosure relates to the technical field of artificial intelligence, and more particularly to a streaming-based compute unit and method, and an artificial intelligence chip.

### BACKGROUND

With the rapid development of deep learning, neural network algorithms have been widely applied to various machine vision projects. A large number of convolutions are usually involved in the practical application process of the neural network algorithms, and artificial intelligence chips usually need to be used to implement the convolutions to improve computation efficiency.

In related technologies, an artificial intelligence chip includes a data buffer configured to buffer data and a compute unit configured to perform computations. In the process of performing a convolution, the compute unit acquires feature map data and convolution kernel data required by the convolution from two data buffers respectively to perform the convolution.

### SUMMARY

According to one aspect of an embodiment of the present disclosure, a streaming-based compute unit is provided and includes N registers, and N≥2. The compute unit is configured to perform N convolutions on N convolution windows and a corresponding convolution kernel, where a j^{th} convolution includes performing M multiplication operations on M feature map data in a j^{th} convolution window and M convolution kernel data in the convolution kernel, to obtain M first computation results. The N convolutions include N multiplication operations sequentially and consecutively performed on at least one set of feature map data and at least one corresponding convolution kernel data in the M convolution kernel data. Each set of feature map data includes N feature map data at a same position corresponding to the N convolution windows, M≥2, and 1≤j≤N. A j^{th} register is configured to store a second computation result of the j^{th} convolution window. After an i^{th} multiplication operation in the M multiplication operations in the j^{th} convolution, the second computation result is updated into a sum of i first computation results of the first i multiplication operations in the M multiplication operations in the j^{th} convolution, and 1≤i≤M.

In some embodiments, the N convolutions include a plurality of groups of multiplication operations performed on a plurality of sets of feature map data and a plurality of corresponding convolution kernel data in the M convolution kernel data, and the plurality of sets of feature map data are in one-to-one correspondence with the plurality of convolution kernel data; each of the plurality of groups of multiplication operations includes N multiplication operations sequentially and consecutively performed on one set of feature map data and one corresponding convolution kernel data; and different sets of feature map data correspond to different positions of the N convolution windows.

In some embodiments, the plurality of sets of feature map data include M sets of feature map data, and the plurality of convolution kernel data include the M convolution kernel data.

In some embodiments, the compute unit further includes: an accumulator configured to accumulate, after the i^{th} multiplication operation in the M multiplication operations in the j^{th} convolution, i−1 first computation results of the first i−1 multiplication operations and a first computation result of the i^{th} multiplication operation in the M multiplication operations in the j^{th} convolution, to obtain a second computation result of the j^{th} convolution window; and a first demutiplexer configured to transmit the second computation result of the j^{th} convolution window to the j^{th} register after the i^{th} multiplication operation in the M multiplication operations in the j^{th} convolution.

In some embodiments, the compute unit further includes: a multiplexer configured to acquire the sum of the i−1 first computation results of the first i−1 multiplication operations from the j^{th} register after the i^{th} multiplication operation in the M multiplication operations in the j^{th} convolution; and a second demutiplexer configured to transmit the sum of the i−1 first computation results of the first i−1 multiplication operations from the multiplexer to the accumulator.

In some embodiments, each feature map data includes feature map sub-data of C channels, each convolution kernel data includes weight data of C channels, and C≥1. The compute unit further includes P multipliers. Each multiplier is configured to multiply feature map sub-data and weight data of a corresponding channel in the i^{th} multiplication operation in the M multiplication operations in the j^{th} convolution, to obtain a third computation result. The P multipliers are in one-to-one correspondence with P channels, and 1≤P≤C. The accumulator is further configured to accumulate C third computation results in the i^{th} multiplication operation in the M multiplication operations in the j^{th} convolution, to obtain the first computation result of the i^{th} multiplication operation.

In some embodiments, C≥2, and the accumulator includes a first accumulator configured to accumulate the C third computation results in the i^{th} multiplication operation in the M multiplication operations in the j^{th} convolution, to obtain the first computation result of the i^{th} multiplication operation; and a second accumulator configured to accumulate the i−1 first computation results of the first i−1 multiplication operations in the M multiplication operations in the j^{th} convolution from the second demutiplexer and the first computation result of the i^{th} multiplication operation from the first accumulator, to obtain the second computation result of the j^{th} convolution window.

In some embodiments, P>2, and the first accumulator includes: at least one third accumulator, each configured to accumulate two third computation results of two multipliers to obtain a fourth computation result; and a fourth accumulator, configured to accumulate the fourth computation result of each third accumulator in the i^{th} multiplication operation of the M multiplication operation in the j^{th} convolution, to obtain the first computation result of the i^{th} multiplication computation.

In these embodiments, an input feature map to be computed includes W convolution windows distributed in a first dimension, the W convolution windows include [W/N] sets of convolution windows, and each set of the convolution windows includes N convolution windows. The compute unit is further configured to perform [W/N] computations. Each computation includes performing the N convolutions on one set of convolution windows and the convolution kernel, and in a case that a remainder D of W/N is not equal to 0, performing, in response to an instruction signal, D convolutions on D convolution windows other than the [W/N] sets of convolution windows in the W convolution windows and the convolution kernel after the [W/N] computations are performed.

In some embodiments, D≥2, and the D convolutions include D multiplication operations sequentially and consecutively performed on at least one set of feature map data and at least one convolution kernel data in the M convolution kernel data. Each set of feature map data corresponding to the D convolutions includes D feature map data at the same position corresponding to the D convolution windows.

According to another aspect of this embodiment of the present disclosure, an artificial intelligence chip is provided and includes the compute unit of any above embodiment, a first storage device and a second storage device. The first storage device includes a first memory, the first memory is configured to store M feature map data of each convolution window of N convolution windows, and the first storage device is configured to receive first read addresses corresponding to a j^{th} convolution, read, according to the first read addresses, each feature map data in the j^{th} convolution window required for performing the j^{th} convolution from the first memory, and transmit each feature map data in the j^{th} convolution window to the compute unit, where the at least one set of feature map data is sequentially and consecutively read and transmitted to the compute unit. The second storage device includes a second memory, the second memory is configured to store M convolution kernel data in a convolution kernel, and the second storage device is configured to receive second read addresses corresponding to the j^{th} convolution, read, according to the second read addresses, each convolution kernel data in the convolution kernel from the second memory, and transmit each convolution kernel data in the convolution kernel to the compute unit, where each convolution kernel data of the at least one convolution kernel data is obtained by performing one read operation on the second memory.

In some embodiments, an input feature map to be computed includes W convolution windows distributed in a first dimension, the W convolution windows include [W/N] sets of convolution windows, and each set of convolution windows includes N convolution windows. The first storage device further includes a data processing circuit, configured to send an instruction signal to the compute unit in a case that the remainder D of W/N is not equal to 0.

The compute unit is further configured to perform [W/N] computations. Each computation includes performing the N convolutions on one set of convolution windows and the convolution kernel, and in response to the instruction signal, D convolutions are performed on D convolution windows other than the [W/N] sets of convolution windows in the W convolution windows and the convolution kernel after the [W/N] computations are performed.

In some embodiments, the first storage device further includes a first control register, configured to send a first drive signal in response to a first configuration signal corresponding to the j^{th} convolution; and a first address generator, configured to generate the first read addresses in response to the first drive signal from the first control register.

In some embodiments, the second storage device further includes a second control register, configured to send a second drive signal in response to a second configuration signal corresponding to the j^{th} convolution; and a second address generator, configured to generate the second read addresses in response to the second drive signal from the second control register.

In some embodiments, the first address generator includes a first set of address generating circuits and a first address combining circuit. The first set of address generating circuits include R first address generating circuits and S second address generating circuits. The R first address generating circuits are in one-to-one correspondence with R second dimensions. An r^{th} first address generating circuit is configured to generate, according to a function yᵣ=floor(aᵣxᵣ+bᵣ)×Tᵣ, a first address yᵣ of each feature map data in an r^{th} second dimension in the j^{th} convolution window required for performing the j^{th} convolution, and 1≤r≤R. The feature map data at different positions in the r^{th} second dimension corresponds to different values of xᵣ, and values of aᵣ, bᵣ, and Tᵣ are set to make different values of xᵣ correspond to different values of yᵣ. The N convolution windows are distributed in S third dimensions. The S second address generating circuits are different from the R first address generating circuits and are in one-to-one correspondence with the S third dimensions. An s^{th} second address generating circuit is configured to generate, according to a function yₛ=floor(aₛxₛ+bₛ)×Tₛ, a second address yₛ of the j^{th} convolution window in an s^{th} third dimension, and 1≤s≤S. Convolution windows at different positions in the s^{th} third dimension correspond to different values of xₛ, and values of aₛ, bₛ, and Tₛ are set to make different values of xₛ correspond to different values of yₛ. The first address combining circuit is configured to generate the first read addresses for acquiring each feature map data in the j^{th} convolution window according to second addresses of the j^{th} convolution window in the S third dimensions and first addresses of each feature map data in the j^{th} convolution window in the R second dimensions.

In some embodiments, the second address generator includes a second set of address generating circuits and a second address combining circuit. The second set of address generating circuits include R third address generating circuits, in one-to-one correspondence with the R second dimensions. An r^{th} third address generating circuit is configured to generate, according to the function yᵣ=floor(aᵣxᵣ+bᵣ)×Tᵣ, a third address yᵣ of each convolution kernel data in the r^{th} second dimension in the convolution kernel required for performing the j^{th} convolution, and 1≤r≤R. The convolution kernel data at different positions in the r^{th} second dimension corresponds to different values of xᵣ, and values of aᵣ, bᵣ, and Tᵣ are set to make different values of xᵣ correspond to different values of yᵣ. The second address combining circuit is configured to generate the second read addresses for acquiring each convolution kernel data in the convolution kernel according to third addresses of each convolution kernel data in the R second dimensions in the convolution kernel.

According to yet another aspect of this embodiment of the present disclosure, an accelerator is provided, and includes the chip of any above embodiment.

According to still another aspect of this embodiment of the present disclosure, a streaming-based compute method is provided, including: performing, by a streaming-based compute unit, N convolutions on N convolution windows and a corresponding convolution kernel, where a j^{th} convolution includes performing M multiplication operations on M feature map data in a j^{th} convolution window and M convolution kernel data in the convolution kernel, to obtain M first computation results; the N convolutions include N multiplication operations sequentially and consecutively performed on at least one set of feature map data and at least one corresponding convolution kernel data in the M convolution kernel data; each set of feature map data includes N feature map data corresponding to the N convolution windows at the same position, N≥2, M≥2, and 1≤j≤N; and storing, by a j^{th} register in N registers of the compute unit, a second computation result of the j^{th} convolution window. After an i^{th} multiplication operation in the M multiplication operations in the j^{th} convolution, the second computation result is updated into the sum of i first computation results of the first i multiplication operations in the M multiplication operations in the j^{th} convolution, and 1≤i≤M.

In some embodiments, the N convolutions include a plurality of groups of multiplication operations performed on a plurality of sets of feature map data and a plurality of corresponding convolution kernel data in the M convolution kernel data, and the plurality of sets of feature map data are in one-to-one correspondence with the plurality of convolution kernel data; each of the plurality of groups of multiplication operations includes N multiplication operations sequentially and consecutively performed on one set of feature map data and one corresponding convolution kernel data; and different sets of feature map data correspond to different positions of the N convolution windows.

In this embodiment of the present disclosure, the streaming-based compute unit can sequentially and consecutively perform, in the convolution, the N convolutions on the at least one set of feature map data and the at least one corresponding convolution kernel data, and thus, in this computation manner, in the at least N convolutions, the compute unit can sequentially perform, only through one convolution kernel data acquired at a time, the convolution on the N feature map data at the same position in the N different convolution windows, and it is unnecessary to repeatedly acquire the same N convolution kernel data for the N feature map data in the N different convolution windows, reducing the power consumption generated in the convolution.

The technical solutions of the present disclosure are further described in detail by the drawings and embodiments as below.

### BRIEF DESCRIPTION OF THE DRAWINGS

In order to describe technical solutions in embodiments of the present disclosure or in the prior art more clearly, the drawings required to be used in descriptions of the embodiments or the prior art will be briefly introduced below, it is apparent that the drawings described below are only some embodiments of the present disclosure, and those of ordinary skill in the art can also obtain other drawings according to the drawings without creative efforts.

FIG. 1 is a schematic diagram of a computation process of convolution according to some embodiments of the present disclosure;

FIG. 2 is a schematic structural diagram of a streaming-based compute unit according to some embodiments of the present disclosure;

FIG. 3 is a schematic diagram of a convolution window and a convolution kernel according to some embodiments of the present disclosure;

FIG. 4 is a schematic structural diagram of a streaming-based compute unit according to some other embodiments of the present disclosure;

FIG. 5 is a schematic diagram of an input feature map according to some embodiments of the present disclosure;

FIG. 6 is a schematic structural diagram of an artificial intelligence chip according to some embodiments of the present disclosure; and

FIG. 7 is a schematic structural diagram of a first address generator according to some embodiments of the present disclosure.

### DETAILED DESCRIPTION

Various exemplary embodiments of the present disclosure will be described in detail below with reference to the accompanying drawings. The descriptions of the exemplary embodiments are only illustrative and should not be adopted to limit the present disclosure, and the application or use thereof. The present disclosure may be implemented in many different forms, which is not limited to the embodiments described herein. The provision of these embodiments is to make the present disclosure thorough and complete, and sufficiently disclose the scope of the present disclosure to those skilled in the art. It should be noted that unless otherwise specifically indicated, relative arrangement of components and steps, material compositions, numeric expressions and values described in these embodiments should be explained as merely illustrative rather than limiting.

“First”, “second” and other similar terms used in the present disclosure are merely used for distinguishing different parts instead of representing any sequence, number or importance. “Comprise” or “include” and other similar terms are intended to indicate that elements before the term cover elements listed behind the term while the possibility of covering other elements is not excluded. “Upper”, “lower”, etc. are merely used for representing a relative position relationship, and when the absolute position of a described object changes, the relative position relationship may correspondingly change.

In the present disclosure, when a specific component is described to be located between a first component and a second component, there may or may not be a middle component between the specific component and the first component or the second component. When the specific component is described to be connected to another component, the specific component may be directly connected to the another component without the middle component, or may be connected to the another component through the middle component.

Unless otherwise specifically defined, all terms (including technological or scientific terms) used in the present disclosure have the same meaning usually understood by those of ordinary skill in the art of the present disclosure. It is also to be understood that the terms defined in a general dictionary, etc. should be explained to be consistent to those in the context in the related technologies in meaning rather than explained with ideal or too formal meaning, unless clearly defined herein.

Technologies, methods and devices known by those of ordinary skill in the related art may not be discussed in detail, but such technologies, methods and devices may be considered as a part of the specification in proper situations.

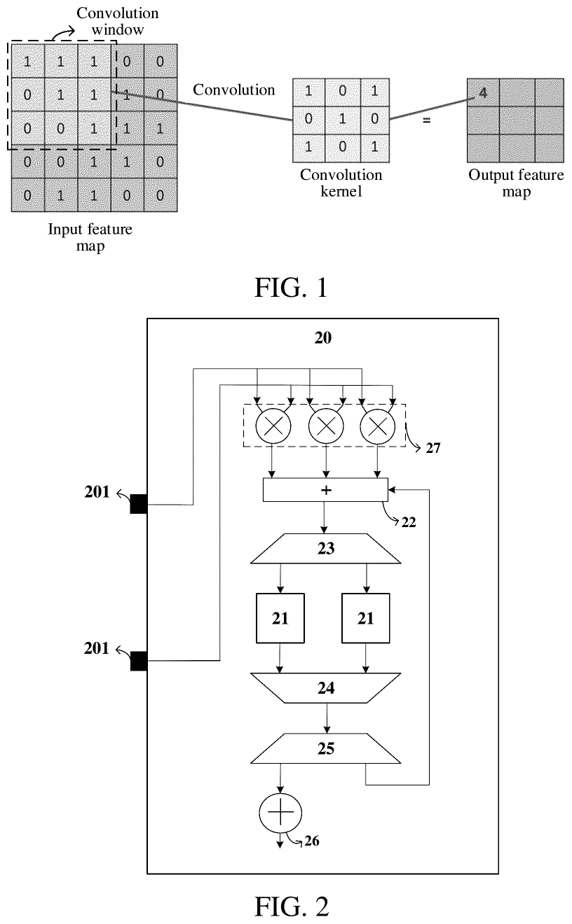

FIG. 1 is a schematic diagram of a computation process of convolution according to some embodiments of the present disclosure.

As shown in FIG. 1, FIG. 1 merely illustrates an input feature map, a convolution kernel and an output feature map (computation of bias data is not involved in the embodiment shown in FIG. 1). In FIG. 1, a left 5×5 2-dimension matrix is the input feature map, a 3×3 2-dimension matrix in a dashed box at an upper left corner of the input feature map is a convolution window, a middle 3×3 2-dimension matrix is a convolution kernel (filter) for convolution with the input feature map, and a right 3×3 2-dimension matrix is the output feature map obtained after the convolution.

In the convolution process, the convolution kernel is placed on the input feature map to slide according to a preset stride to generate a plurality of convolution windows, feature map data in each convolution window of the plurality of convolution windows is multiplied by convolution kernel data in the convolution kernel at the same position in a one-to-one-correspondence manner, all products of each convolution window are accumulated, and accordingly, a convolution result of the output feature map can be obtained. For example, after the convolution is performed on the 3×3 convolution window in the dashed box at the upper left corner of the input feature map and the middle 3×3 convolution kernel, a convolution result (i.e., 4) of the output feature map can be obtained.

Through the analysis, the inventor has found that in the manner in the related technologies, the compute unit sequentially performs the convolution on the plurality of convolution windows and the corresponding convolution kernel, that is, after the convolution is first performed on one convolution window and the convolution kernel, the convolution continues to be performed on another convolution window and the same convolution kernel. For the plurality of feature map data in the plurality of convolution windows at the same position, the compute unit needs to repeatedly acquire convolution kernel data in the convolution kernel at the corresponding position, causing high power consumption in the convolution.

In order to solve the above problems, this embodiment of the present disclosure provides the following solutions.

According to one aspect of this embodiment of the present disclosure, a streaming-based compute unit is provided.

The streaming-based compute unit includes N registers, and N≥2. In other embodiments, the streaming-based compute unit may further include other components, which will be described later.

The streaming-based compute unit is configured to perform N convolutions on N convolution windows and a corresponding convolution kernel. The number of convolution kernel data in each convolution window and the number of convolution kernel data in the convolution kernel are both M, and M≥2.

A j^{th} convolution includes performing M multiplication operations on M feature map data in a j^{th} convolution window and M convolution kernel data in the convolution kernel, to obtain M first computation results, and 1≤j≤N. For example, a first convolution includes performing M multiplication operations on M feature map data in a first convolution window and M convolution kernel data in the convolution kernel, to obtain M first computation results; a second convolution includes performing M multiplication operations on M feature map data in a second convolution window and M convolution kernel data in the convolution kernel, to obtain M first computation results; and so on.

For another example, referring to FIG. 1, the 3×3 convolution window in the dashed box at the upper left corner of the input feature map is denoted by the first convolution window in the input feature map, and the first convolution may include performing 9 multiplication operations on 9 feature map data in the first convolution window and 9 convolution kernel data in the middle 3×3 convolution kernel, to obtain 9 first computation results.

In the 9 first computation results, the 1st first computation result may be a result obtained after the multiplication operation on row-1 and column-1 feature map data in the first convolution window and row-1 and column-1 convolution kernel data in the convolution kernel; the 2nd first computation result may be a result obtained after the multiplication operation on row-1 and column-2 feature map data in the first convolution window and row-1 and column-2 convolution kernel data in the convolution kernel; and so on.

The N convolutions include N multiplication operations sequentially and consecutively performed on at least one set of feature map data and at least one corresponding convolution kernel data in the M convolution kernel data. Each set of feature map data includes N feature map data corresponding to the N convolution windows at the same position.

It is to be understood that the N feature map data required for the sequential and consecutive N convolutions on the one set of feature map data and the corresponding convolution kernel data are from the same position in the N different convolution windows, the required convolution kernel data is from the position in the convolution kernel corresponding to the same position, and the number of the required convolution kernel data is 1 rather than N.

For example, still referring to FIG. 1, assuming that the stride between the convolution windows is 1, there are three 3×3 convolution windows in the row direction of the input feature map. N may be 2 or 3. Taking N of 3 as an example, three feature map data at a first row and a first column of the three convolution windows (i.e., three feature map data at a first row and a first column, a first row and a second column and a first row and a third column in the input feature map) may serve as one set of feature map data to be sequentially and consecutively multiplied three times by one row-1 and column-1 convolution kernel data from the convolution kernel. In other words, for the row-1 and column-1 convolution kernel data, the feature map data at the corresponding positions of the three convolution windows are alternately multiplied by the convolution kernel data.

It should be noted that the three feature map data at the first row and the first column in the three convolution windows are adopted as an example for explanation, but the present disclosure is not limited thereto. Feature map data at other positions in the three convolution windows may also be computed with reference to the above manner. For example, three feature map data at a first row and a second column of the three convolution windows (i.e., three feature map data at a first row and a second column, a first row and a third column and a first row and a fourth column in the input feature map) may serve as one set of feature map data to be sequentially and consecutively multiplied three times by one row-1 and column-2 convolution kernel data from the convolution kernel.

A j^{th} register is configured to store a second computation result of the j^{th} convolution window.

After an i^{th} multiplication operation in the M multiplication operations in the j^{th} convolution, the second computation result of the j^{th} convolution window is updated into a sum of i first computation results of the first i multiplication operations in the M multiplication operations in the j^{th} convolution, and 1≤i≤M. In some embodiments, the compute unit is further configured to output a sum of the M first computation results of the M multiplication operations in the j^{th} convolution to serve as a convolution result of the output feature map.

To facilitate understanding, an example shown in FIG. 1 is still adopted for explanation. The first convolution performed on the first convolution window and the convolution kernel includes the 9 multiplication operations.

After a first multiplication operation in the first convolution, a second computation result of a first convolution window in a first register is updated into a first computation result of the first multiplication operation (i.e., 1×1); after a second multiplication operation (i.e., 1×0) in the first convolution, the second computation result of the first convolution window in the first register is updated into a sum (i.e., a sum of 1×1 and 1×0) of the two first computation results of the first multiplication operation and the second multiplication operation in the first convolution; after a third multiplication operation (i.e., 1×1) in the first convolution, the second computation result of the first convolution window in the first register is updated into a sum (i.e., a sum of 1×1, 1×0 and 1×1) of the three first computation results of the first three multiplication operations in the first convolution; and in a similar way, after a ninth multiplication operation (i.e., 1×1) in the first convolution, the second computation result of the first convolution window in the first register is updated into a sum of the nine first computation results of the first nine multiplication operations, the sum of the nine first computation results is a convolution result of the output feature map after the first convolution on the first convolution window and the convolution kernel.

If there are three 3×3 convolution windows arranged in the row direction of the input feature map, because N is 3, after the compute unit performs three convolutions on the three convolution windows and the convolution kernel, three convolution results of the output feature map may be obtained. Each convolution includes performing the 9 multiplication operations on nine feature map data in one convolution window and nine convolution kernel data in the convolution kernel.

In the above embodiment, the streaming-based compute unit can sequentially and consecutively perform, in the convolution, the N convolutions on the at least one set of feature map data and the at least one corresponding convolution kernel data, and thus, in this computation manner, in the at least N convolutions, the compute unit can sequentially perform, only through one convolution kernel data acquired at a time, the convolution on the N feature map data at the same position in the N different convolution windows, and it is unnecessary to repeatedly acquire the same N convolution kernel data for the N feature map data in the N different convolution windows, reducing the power consumption generated in the convolution.

In some embodiments, the N convolutions may include a plurality of groups of multiplication operations performed on a plurality of sets of feature map data and a plurality of corresponding convolution kernel data in M convolution kernel data, and each of the plurality of groups of multiplication operations includes N multiplication operations sequentially and consecutively performed on one set of feature map data and one corresponding convolution kernel data. The plurality of sets of feature map data are in one-to-one correspondence with the plurality of convolution kernel data, and different sets of feature map data correspond to different positions of the N convolution windows.

It is to be understood that the correspondence between the plurality of sets of feature map data and the plurality of convolution kernel data refers to positional correspondence between the plurality of sets of feature map data and the plurality of convolution kernel data.

For example, still referring to FIG. 1, assuming that the stride between the convolution windows is 1, there are three 3×3 convolution windows in the row direction of the input feature map, nine sets of feature map data are in one-to-one correspondence with nine different positions in the convolution windows and nine convolution kernel data at nine different positions in the convolution kernel. If N is 3, each set of the nine sets of feature map data includes three feature map data. For example, the first set of feature map data may include three feature map data at the first row and the first column, the first row and the second column and the first row and the third column in the input feature map; the second set of feature map data may include three feature map data at the first row and the second column, the first row and the third column and the first row and the fourth column in the input feature map; and so on.

The N convolutions may include a plurality of groups of multiplication operations performed on a plurality of sets of feature map data in the nine sets of feature map data and a plurality of corresponding convolution kernel data in the nine convolution kernel data.

Accordingly, the power consumption generated in the convolution can be further reduced.

In some embodiments, a plurality of sets of feature map data required for performing a plurality of groups of multiplication operations may include M sets of feature map data, and a plurality of required convolution kernel data may include M convolution kernel data. That is, the N convolutions may include M groups of multiplication operations performed on the M sets of feature map data and the M convolution kernel data. Each group of multiplication operation includes N multiplication operations sequentially and consecutively performed on one set of feature map data and one corresponding convolution kernel data, and the M sets of feature map data are in one-to-one correspondence with the M convolution kernel data and M different positions in N convolution windows.

Accordingly, in M×N convolutions, the compute unit can sequentially perform the M×N convolutions, only through M convolution kernel data acquired M times, with N feature map data at the corresponding same position in N different convolution windows. In this computation manner, the compute unit only needs to acquire each convolution kernel data of the M convolution kernel data once without repeatedly acquiring each convolution kernel data N times, further reducing the power consumption generated in the convolution.

It is to be understood that the above multiplication operations may be performed by a multiplier in the compute unit.

FIG. 2 is a schematic structural diagram of a streaming-based compute unit according to some embodiments of the present disclosure.

As shown in FIG. 2, the compute unit 20 may include N registers 21 (FIG. 2 schematically illustrates two registers 21), an accumulator 22 and a first demutiplexer 23. There may be one or more accumulators 22, which will be further described later by combining some embodiments.

The accumulator 22 may be configured to accumulate, after an i^{th} multiplication operation in M multiplication operations in a j^{th} convolution, i−1 first computation results of the first i−1 multiplication operations in the M multiplication operations in the j^{th} convolution and a first computation result of the i^{th} multiplication operation, to obtain a second computation result of a j^{th} convolution window. It should be noted that in the case of i=1, the second computation result of the j^{th} convolution window is the first computation result of the first multiplication operation.

It is to be understood that in a case that data required for performing the convolution does not include bias data, after the Mth multiplication operation in the M multiplication operations in the j^{th} convolution, the second computation result (i.e., the sum of the M first computation results of the first M multiplication operations) of the j^{th} convolution window obtained by the accumulator 22 is a convolution result of the output feature map.

The first demutiplexer 23 may be configured to transmit the second computation result of the j^{th} convolution window to a j^{th} register 21 after the i^{th} multiplication operation in the M multiplication operations in the j^{th} convolution.

As some implementations, the first demutiplexer 23 may be a single-input, multiple-output selector. For example, the first demutiplexer 23 may include a first input end connected to the accumulator 22 and N first output ends connected to the N registers 21 in a one-to-one correspondence manner. The first input end may be configured to receive the second computation result of the j^{th} convolution window from the accumulator 22 after the i^{th} multiplication operation in the M multiplication operations in the j^{th} convolution. The j^{th} first output end may be configured to transmit the second computation result of the j^{th} convolution window to the j^{th} register 21 after the i^{th} multiplication operation in the M multiplication operations in the j^{th} convolution.

Accordingly, the first demutiplexer correspondingly transmits the second computation result of the j^{th} convolution window to the j^{th} register after the i^{th} multiplication operation in the j^{th} convolution, updating the second computation result stored in the j^{th} register.

In some embodiments, still referring to FIG. 2, the compute unit 20 may further include a multiplexer 24 and a second demutiplexer 25.

The multiplexer 24 may be configured to acquire the sum of the i−1 first computation results of the first i−1 multiplication operations from the j^{th} register 21 after the i^{th} multiplication operation in the M multiplication operations in the j^{th} convolution.

For example, the multiplexer 24 may include N second input ends connected to the N registers 21 in a one-to-one correspondence manner, and a second output end connected to the second demutiplexer 25. The j^{th} second input end may be configured to acquire the sum of the i−1 first computation results of the first i−1 multiplication operations from the j^{th} register 21. The second output end may be configured to transmit the sum of the i−1 first computation results of the first i−1 multiplication operations to the second demutiplexer 25.

It is to be understood that after the (i−1)th multiplication operation in the M multiplication operations in the j^{th} convolution, the second computation result of the j^{th} convolution window stored in the j^{th} register 21 is the sum of the i−1 first computation results of the first i−1 multiplication operations.

The second demutiplexer 25 may be configured to transmit the sum of the i−1 first computation results of the first i−1 multiplication operations to the accumulator 22.

As some implementations, the second demutiplexer 25 may include a third input end connected to the multiplexer 24 and a third output end connected to the accumulator 22. The third input end may be configured to receive the sum of the i−1 first computation results of the first i−1 multiplication operations from the multiplexer 24. The third output end may be configured to transmit the sum of the i−1 first computation results of the first i−1 multiplication operations to the accumulator 22.

In some embodiments, the second demutiplexer 25 may further include a fourth output end different from the third output end. The fourth output end may be configured to output, after the Mth multiplication operation in the M multiplication operations in the j^{th} convolution, the sum of the M first computation results of the first M multiplication operations (i.e., the second computation result of the j^{th} convolution window after the Mth multiplication operation). For example, the fourth output end may output the second computation result of the j^{th} convolution window after the Mth multiplication operation to a memory unit connected to the compute unit 20.

In some embodiments, as shown in FIG. 2, in a case that data required for performing the convolution further includes bias data, the fourth output end of the second demutiplexer 25 may be connected to the accumulator 26. The accumulator 26 may be configured to accumulate, after the Mth multiplication operation in the M multiplication operations in the j^{th} convolution, the sum of the M first computation results from the second demutiplexer 25 after the first M multiplication operations and the preset bias data, and output an accumulated convolution result. Accordingly, the compute unit 20 may further support convolution with the bias data.

In some embodiments, each feature map data includes feature map sub-data of C channels, each convolution kernel data includes weight data of C channels, and C≥1.

In these embodiments, still referring to FIG. 2, the compute unit 20 may further include P multipliers 27 (FIG. 2 schematically illustrates three multipliers 27). The P multipliers 27 are in one-to-one correspondence with P channels, and 1≤P≤C.

For example, as shown in FIG. 2, the compute unit 20 may include two input ends 201. Each multiplier 27 may be respectively connected to the two input ends 201 of the compute unit 20 through two data paths to receive feature map sub-data of a corresponding channel input by one input end 201 and weight data of a corresponding channel input by the other input end 201.

Each multiplier 27 may be configured to multiply feature map sub-data and weight data of a corresponding channel in the i^{th} multiplication operation in the M multiplication operations in the j^{th} convolution, to obtain a third computation result.

The accumulator 22 may be further configured to accumulate C third computation results in the i^{th} multiplication operation in the M multiplication operations in the j^{th} convolution, to obtain the first computation result of the i^{th} multiplication operation.

In some embodiments, P may be greater than or equal to 2. Accordingly, the plurality of multipliers may perform multi-channel multiplication operations in parallel according to the feature map sub-data from the plurality of channels and the weight data from the plurality of channels, improving the computing speed of the compute unit.

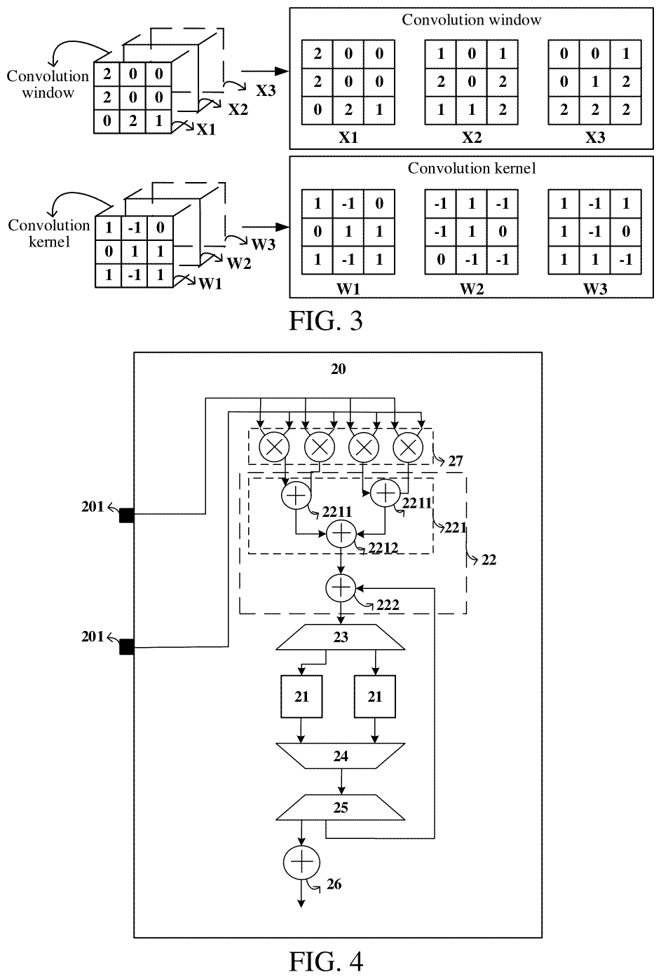

A further description is given below with a convolution window and a convolution kernel shown in FIG. 3 as an example.

FIG. 3 is a schematic diagram of a convolution window and a convolution kernel according to some embodiments of the present disclosure.

As shown in FIG. 3, FIG. 3 schematically illustrates a convolution window with three channels (X1-X3) and a convolution kernel with three channels (W1-W3). Each feature map data includes three feature map sub-data from three channels (X1-X3), and each convolution kernel data includes three weight data from three channels (W1-W3).

For example, feature map data at a first row and a first column in the convolution window includes feature map sub-data 2 at a first row and a first column in a first channel X1, feature map sub-data 1 at a first row and a first column in a second channel X2, and feature map sub-data 0 at a first row and a first column in a third channel X3. Convolution kernel data at a first row and a first column in the convolution kernel includes weight data 1 at a first row and a first column in a first channel W1, weight data −1 at a first row and a first column in a second channel W2, and weight data 1 at a first row and a first column in a third channel W3; and so on.

When a first multiplication operation is performed on the feature map data at the first row and the first column in the convolution window and the convolution kernel data at the first row and the first column in the convolution kernel,
the first multiplier 27 may be configured to multiply the feature map sub-data at the first row and the first column in the first channel X1 and the weight data at the first row and the first column in the first channel W1 to obtain a third computation result, for example, the third computation result obtained by the first multiplier 27 in the first multiplication operation may be 2*1;
the second multiplier 27 may be configured to multiply the feature map sub-data at the first row and the first column in the second channel X2 and the weight data at the first row and the first column in the second channel W2 to obtain a third computation result, for example, the third computation result obtained by the second multiplier 27 in the first multiplication operation may be 1*(−1);
the third multiplier 27 may be configured to multiply the feature map sub-data at the first row and the first column in the third channel X3 and the weight data at the first row and the first column in the third channel W3 to obtain a third computation result, for example, the third computation result obtained by the third multiplier 27 in the first multiplication operation may be 0*1; and
the accumulator 22 may be further configured to accumulate the three third computation results in the first multiplication operation, to obtain the first computation result of the first multiplication operation 2*1+1*(−1)+0*1=1.

When a second multiplication operation is performed on the feature map data at the first row and the second column in the convolution window and the convolution kernel data at the first row and the second column in the convolution kernel,
the first multiplier 27 may be configured to multiply the feature map sub-data at the first row and the second column in the first channel X1 and the weight data at the first row and the second column in the first channel W1 to obtain a third computation result, for example, the third computation result obtained by the first multiplier 27 in the second multiplication operation may be 0*(−1);
the second multiplier 27 may be configured to multiply the feature map sub-data at the first row and the second column in the second channel X2 and the weight data at the first row and the second column in the second channel W2 to obtain a third computation result, for example, the third computation result obtained by the second multiplier 27 in the second multiplication operation may be 0*1;
the third multiplier 27 may be configured to multiply the feature map sub-data at the first row and the second column in the third channel X3 and the weight data at the first row and the second column in the third channel W3 to obtain a third computation result, for example, the third computation result obtained by the third multiplier 27 in the second multiplication operation may be 0*(−1); and
the accumulator 22 may be further configured to accumulate the three third computation results in the second multiplication operation, to obtain a first computation result of the second multiplication operation, which is 0*(−1)+0*1+0*(−1)=0.

The subsequent multiplication operations in the nine multiplication operations on the nine feature map data in the convolution window and the nine convolution kernel data in the convolution kernel may be deduced in a similar way, which are not described in detail herein.

FIG. 4 is a schematic structural diagram of a streaming-based compute unit according to some other embodiments of the present disclosure.

As shown in FIG. 4, in a case that C is greater than or equal to 2, the accumulator 22 in the compute unit 20 may include a first accumulator 221 and a second accumulator 222.

The first accumulator 221 may be configured to accumulate C third computation results in the i^{th} multiplication operation in the M multiplication operations in the j^{th} convolution, to obtain the first computation result of the i^{th} multiplication operation.

For example, in the example shown in FIG. 3, the first accumulator 221 may accumulate the three third computation results (2*1, 1*(−1) and 0*1) in the first convolution, to obtain the first computation result (1-2*1+1*(−1)+0*1) of the first convolution.

The second accumulator 222 may be configured to accumulate the i−1 first computation results of the first i−1 multiplication operations in the M multiplication operations in the j^{th} convolution from the second demutiplexer 25 and the first computation result of the i^{th} multiplication operation from the first accumulator 221, to obtain the second computation result of the j^{th} convolution window.

For example, the second accumulator 222 may be connected to the first demutiplexer 23, such that the first demutiplexer 23 may transmit the second computation result of the j^{th} convolution window to the j^{th} register after the i^{th} multiplication operation in the M multiplication operations in the j^{th} convolution. The second computation result of the j^{th} convolution window is the sum of the i first computation results of the first i multiplication operations.

In some embodiments, P may be greater than 2. In these embodiments, the first accumulator 221 may include Q third accumulators connected to Q sets of multipliers in a one-to-one correspondence manner and a fourth accumulator. Each set of multipliers includes two multipliers, 1≤Q≤[P/2], and Q is a positive integer.

Each third accumulator may be configured to accumulate two third computation results of a corresponding set of multipliers, to obtain a fourth computation result.

The fourth accumulator may be configured to accumulate Q fourth computation results in the i^{th} multiplication operation in the M multiplication operations in the j^{th} convolution and P−2Q third computation results, to obtain the first computation result of the i^{th} multiplication operation.

For example, still referring to FIG. 4, the first accumulator 221 may include at least one third accumulator 2211 and a fourth accumulator 2212. FIG. 4 schematically illustrates P=4 multipliers 27 and two third accumulators 2211.

Each third accumulator 2211 may be correspondingly connected to one set of multipliers 27, to receive the two third computation results from the two multipliers 27 in the set of multipliers 27. The fourth accumulator 2212 may be connected to each third accumulator 2211, to receive the fourth computation result of each third accumulator 2211.

Each third accumulator 2211 may be configured to accumulate the two third computation results of the two multipliers 27, to obtain the fourth computation result.

The fourth accumulator 2212 may be configured to accumulate the fourth computation result of each third accumulator in the i^{th} multiplication operation in the M multiplication operations in the j^{th} convolution, to obtain the first computation result of the i^{th} multiplication operation.

In some embodiments, in a case that a remainder of P/2 is not 0, the fourth accumulator 2212 may be further configured to accumulate the fourth computation result of each third accumulator in the i^{th} multiplication operation in the M multiplication operations in the j^{th} convolution and P−2Q third computation results, to obtain the first computation result of the i^{th} multiplication operation. Q denotes the number of the third accumulators 2211 in the compute unit 20.

For example, in a case that P is equal to 5, and the number Q of the third accumulators 2211 is 2, a third computation result of one of the five multipliers 27 not connected to the third accumulator 2211 cannot be accumulated by the third accumulator 2211. In this situation, the fourth accumulator 2212 may further accumulate two fourth computation results from the two accumulators 2211 in the i^{th} multiplication operation and the third computation result of one multiplier 27 not connected to the third accumulator 2211, to obtain the first computation result of the i^{th} multiplication operation.

In the above embodiment, the process that the C third computation results in the i^{th} multiplication operation are accumulated to obtain the first computation result in the i^{th} multiplication operation may be divided by arranging the fourth accumulator and the at least one third accumulator, that is, the at least one third accumulator may accumulate two third computation results of at least one set of multipliers in parallel, and then, the fourth accumulator accumulates the computation result of each third accumulator to obtain the first computation result. Accordingly, time consumed in the process of acquiring the first computation result in the i^{th} multiplication operation is shortened, improving the convolution efficiency.

In some embodiments, an input feature map to be computed may include W convolution windows distributed in a first dimension, the W convolution windows may include [W/N] sets of convolution windows, and each set of convolution windows may include N convolution windows.

In these embodiments, the compute unit may be further configured to perform [W/N] computations. Each computation includes performing N convolutions on one set of convolution windows and a convolution kernel, and in a case that a remainder D of W/N is not equal to 0, performing, in response to an instruction signal, D convolutions on D convolution windows other than the [W/N] sets of convolution windows in the W convolution windows and the convolution kernel after the [W/N] computations are performed.

It is to be understood that in the convolution, the first dimension may be any one of a height dimension and a width dimension.

It is to be further understood that the different sets of convolution windows may correspond to different positions in the input feature map. The N convolutions involved in each computation are similar to the N convolutions performed on the N convolution windows and the corresponding convolution kernel in any above embodiment, which may be similarly implemented with reference to the manner of the foregoing related embodiments, and is not described in detail herein.

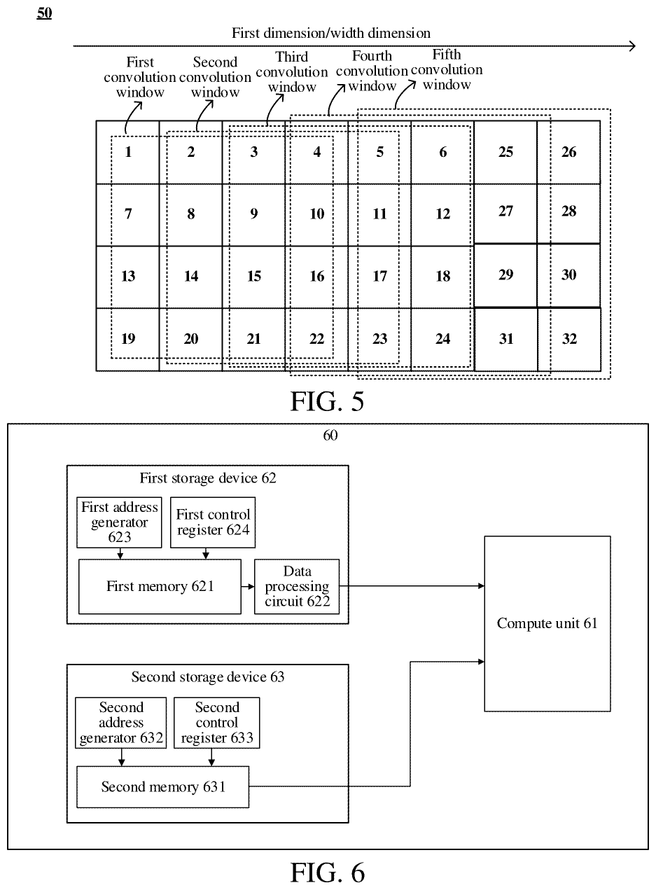

Further descriptions are made by combining FIG. 5 below. FIG. 5 is a schematic diagram of an input feature map according to some embodiments of the present disclosure.

As shown in FIG. 5, the input feature map 50 may include W convolution windows distributed in a first dimension. FIG. 5 schematically illustrates five convolution windows distributed in a width dimension, and a 4×4 matrix in a dashed box denotes one convolution window.

For example, N=2, and the input feature map 50 may include [W/N]=2 sets of convolution windows, and each set of convolution windows may include two convolution windows.

The compute unit (e.g., the compute unit 20 of any above embodiment) may perform two computations. The first computation may include performing two convolutions on the first set of convolution windows (i.e., the first convolution window and the second convolution window distributed in the first dimension) and a convolution kernel; and the second computation may include performing two convolutions on the second set of convolution windows (i.e., the third convolution window and the fourth convolution window distributed in the first dimension) and the convolution kernel. In the process of the two computations, the power consumption generated in the convolution can be reduced.

Because the remainder D of W/N is 1, after the two computations are performed, the compute unit may perform, in response to the instruction signal, one convolution on one convolution window other than the two sets of convolution windows in the five convolution windows (i.e., the five convolution windows distributed in the first dimension) and the convolution kernel.

Accordingly, the compute unit may group every N convolution windows in the input feature map as one set. The N convolutions are performed on every N convolution windows and the corresponding convolution kernel according to the related manner of the foregoing embodiments, and in a case that the number of convolution windows distributed in a certain dimension is not an integer multiple of N, the remaining convolution windows may be computed as one set. In this computation manner, the compute unit may support the convolution of any number of convolution windows, improving universality of the compute unit.

In some embodiments, D≥2, and D convolutions may include D multiplication operations sequentially and consecutively performed on at least one set of feature map data and at least one M convolution kernel data. Each set of feature map data corresponding to the D convolutions includes D feature map data corresponding to the D convolution windows at the same position.

For example, the input feature map may include ten convolution windows distributed in the width dimension. Each set of convolution windows may include four convolution windows, that is, the compute unit may perform one computation with the four convolution windows as one set. After the compute unit performs two computations, the compute unit may perform one computation again with the two remaining convolution windows as one set. Moreover, for the one computation performed on the two remaining convolution windows, if each convolution window is a 4×4 matrix (i.e., including 16 feature map data), the compute unit may adopt two feature map data at the same position corresponding to the two convolution windows as one set of feature map data, and sequentially and consecutively perform two multiplication operations on at least one set of 16 sets of the feature map data and at least one corresponding convolution kernel data.

Accordingly, in a case that there are a plurality of convolution windows remaining, the compute unit may adopt the plurality of convolution windows as one set and adopt a manner similar to the manner of performing the N convolutions in the foregoing embodiments to perform the convolution on the remaining set of convolution windows, further reducing the power consumption for performing the convolution.

According to another aspect of this embodiment of the present disclosure, an artificial intelligence chip is provided.

FIG. 6 is a schematic structural diagram of an artificial intelligence chip according to some embodiments of the present disclosure.

As shown in FIG. 6, the artificial intelligence chip 60 may include a compute unit 61 (e.g., the compute unit 20 of any above embodiment), a first storage device 62 and a second storage device 63. It is to be understood that there may be one or more compute units 61.

The first storage device 62 may include a first memory 621. The first memory 621 may be configured to store M feature map data in each convolution window of N convolution windows.

In some embodiments, the first storage device 62 may be a data buffer. The first memory 621 may be a random access memory (Random Access Memory, RAM).

The first storage device 62 may be configured to receive first read addresses corresponding to a j^{th} convolution, read, according to the first read addresses, each feature map data in a j^{th} convolution window required for performing the j^{th} convolution from the first memory 621, and transmit each feature map data in the j^{th} convolution window to the compute unit 61.

At least one set of feature map data may be sequentially and consecutively read by the first storage device 62 and transmitted to the compute unit 61, such that the compute unit 61 may sequentially and consecutively perform N multiplication operations on the at least one set of feature map data and at least one corresponding convolution kernel data.

The second storage device 63 may include a second memory 631. The second memory 631 may be configured to store M convolution kernel data in a convolution kernel.

In some embodiments, the second storage device 63 may be the data buffer, and the second memory 631 may be the RAM.

The second storage device 63 may be configured to receive second read addresses corresponding to the j^{th} convolution, read, according to the second read addresses, each convolution kernel data in the convolution kernel from the second memory 631, and transmit each convolution kernel data in the convolution kernel to the compute unit 61.

Each convolution kernel data of the at least one convolution kernel data may be obtained by performing one read operation on the second memory 631 in the second storage device 63.

Accordingly, in at least N convolutions, the second storage device 63 does not need to repeatedly acquire, for N feature map data at the same position in the N different convolution windows, the same N convolution kernel data from the second memory 631, reducing power consumption of the second storage device 63 and then reducing power consumption of the artificial intelligence chip 60.

In some embodiments, an input feature map to be computed may include W convolution windows distributed in a first dimension, the W convolution windows include [W/N] sets of convolution windows, and each set of convolution windows includes N convolution windows.

In these embodiments, as shown in FIG. 6, the first storage device 62 may further include a data processing circuit 622.

The data processing circuit 622 is configured to send an instruction signal to the compute unit 61 in a case that the remainder D of W/N is not equal to 0.

The compute unit 61 may be further configured to perform [W/N] computations. Each computation includes performing N convolutions on one set of convolution windows and the convolution kernel, and performing, in response to the instruction signal, D convolutions on D convolution windows other than the [W/N] sets of convolution windows in the W convolution windows and the convolution kernel after the [W/N] computations are performed.

In some embodiments, D≥2, and D convolutions may include D multiplication operations sequentially and consecutively performed on at least one set of feature map data and at least one M convolution kernel data. Each set of feature map data corresponding to the D convolutions includes D feature map data corresponding to the D convolution windows at the same position.

In some embodiments, as shown in FIG. 6, the first storage device 62 may further include a first address generator 623 and a first control register 624.

The first control register 624 may be configured to send a first drive signal in response to a first configuration signal corresponding to the j^{th} convolution. The first address generator 623 may be configured to generate the first read addresses in response to the first drive signal from the first control register 624 for acquiring each feature map data in the j^{th} convolution window.

In some embodiments, still referring to FIG. 6, the second storage device 63 may further include a second address generator 632 and a second control register 633.

The second control register 633 may be configured to send a second drive signal to the second address generator 632 in response to a second configuration signal corresponding to the j^{th} convolution. The second address generator 632 may be configured to generate the second read addresses in response to the second drive signal from the second control register 633 for acquiring each convolution kernel data in the convolution kernel. A manner of generating the first read addresses by the first address generator 623 and a manner of generating the second read addresses by the second address generator 632 are described later.

In some embodiments, the first control register 624 may be further configured to send a third drive signal to the data processing circuit 622 in a case that D is not equal to 0. In these embodiments, the data processing circuit 622 may be configured to send, in response to the third drive signal, the instruction signal to the compute unit 61.

The manner of generating the first read addresses by the first address generator 623 is described in combination with some embodiments below.

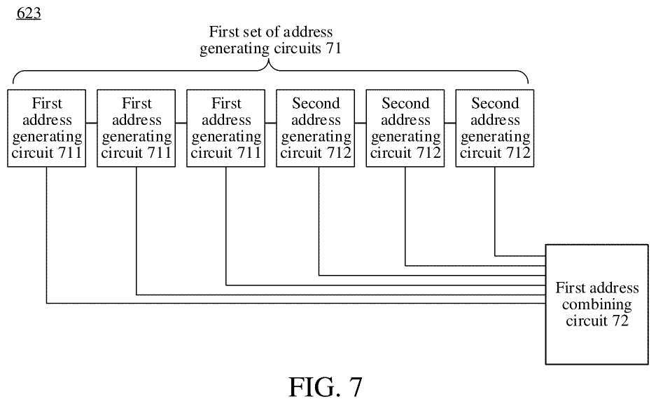

FIG. 7 is a schematic structural diagram of a first address generator according to some embodiments of the present disclosure.

As shown in FIG. 7, the first address generator 623 may include a first set of address generating circuits 71 and a first address combining circuit 72.

The first set of address generating circuits 71 may include R first address generating circuits 711, and S second address generating circuits 712 different from the R first address generating circuits 711. R and S are both integers greater than or equal to 1.

It is to be understood that besides the R first address generating circuits 711 and the S second address generating circuits 712, the first set of address generating circuits 71 may further include other address generating circuits. FIG. 7 schematically illustrates the first set of address generating circuits 71 including three first address generating circuits 711 and three second address generating circuits 712.

The R first address generating circuits 711 are in one-to-one correspondence with R second dimensions. That is, an r^{th} first address generating circuit in the R first address generating circuits 711 corresponds to an r^{th} second dimension in the R second dimensions, and 1≤r≤R.

The R second dimensions refer to the dimension of feature map data in a j^{th} convolution window required for performing a j^{th} convolution, that is, the feature map data in the j^{th} convolution window is distributed along the R second dimensions, and the j^{th} convolution window is an R-dimension matrix.

N convolution windows required for performing the N convolutions are distributed along S third dimensions. The S second address generating circuits 712 are in one-to-one correspondence with the S third dimensions. That is, an s^{th} second address generating circuit in the S second address generating circuits 712 corresponds to an s^{th} third dimension in the S third dimensions, and 1≤s≤S.

It is to be understood that the R second dimensions and the S third dimensions may be completely the same, partially the same or completely different. In the convolution, the R second dimensions may include at least one height dimension, a width dimension and a channel dimension, and the S third dimensions may also include at least one height dimension, the width dimension and the channel dimension.

An r^{th} first address generating circuit is configured to generate, according to a function yᵣ floor(aᵣxᵣ+bᵣ)×Tᵣ, a first address yᵣ of each feature map data in an r^{th} second dimension in the j^{th} convolution window required for performing the j^{th} convolution. The feature map data at different positions in the r^{th} second dimension corresponds to different values of xᵣ, and values of aᵣ, bᵣ, and Tᵣ are set to make different values of xᵣ correspond to different values of yᵣ.

For example, the 1st first address generating circuit 711 is configured to generate, according to a function yᵣ₌₁=floor(aᵣ₌₁xᵣ₌₁+bᵣ₌₁)×Tᵣ₌₁, a first address yᵣ₌₁ of each feature map data in the 1st second dimension in the j^{th} convolution window required for performing the j^{th} convolution; the 2nd first address generating circuit 711 is configured to generate, according to a function yᵣ₌₂=floor(aᵣ₌₂xᵣ₌₂+bᵣ₌₂)×Tᵣ₌₂, a first address yᵣ₌₂ of each feature map data in the 2nd second dimension in the j^{th} convolution window required for performing the j^{th} convolution; and so on.

Similarly, the S^{th} second address generating circuit 712 is configured to generate, according to a function yₛ=floor(aₛxₛ+bₛ)×Tₛ, a second address yₛ of the j^{th} convolution window in an s^{th} third dimension. Different convolution windows in the s^{th} third dimension correspond to different values of xₛ, and values of aₛ, bₛ, and Tₛ are set to make different values of xₛ correspond to different values of yₛ.

In other words, each first address generating circuit and each second address generating circuit are both configured to generate, according to a function y=floor(ax+b)×T, an address y, where x is a variable, and a, b and T are constants. For example, a and T may be greater than 0, b may be greater than or equal to 0, and x may be an integer greater than or equal to 0. T may denote a mapping relationship between floor(ax+b) and the address y.

It is to be understood that values of a, b, and T corresponding to the different first address generating circuits may be the same or different, values of a, b, and T corresponding to the different second address generating circuits may be the same or different, and values of a, b, and T corresponding to any first address generating circuit and any second address generating circuit may be the same or different.

It is to be further understood that when different convolutions are performed, values of a, b, and T corresponding to the same first address generating circuit may be the same or different, and values of a, b, and T corresponding to the same second address generating circuit may be the same or different.

Values of a, b, and T respectively corresponding to each first address generating circuit and each second address generating circuit may be flexibly configured according to actual computation requirements, such that the S second address generating circuits 712 generate, according to the above manner, second addresses of each convolution window in the S third dimensions required for performing the convolution, and the R first address generating circuits 711 generate, according to the above manner, first addresses of each feature map data in each convolution window in the R second dimensions required for performing the convolution.

It is to be understood that based on S second addresses of any convolution window in the S third dimensions, the convolution window may be uniquely determined from the plurality of convolution windows. In addition, based on R first addresses of any feature map data in the R second dimensions, the feature map data may be uniquely determined in the convolution window where the feature map data is located. In other words, one feature map data in one convolution window can be uniquely determined according to second addresses of any convolution window in the S third dimensions and first addresses of any feature map data in the convolution window in the R second dimensions.

The first address combining circuit 72 is configured to generate first read addresses for acquiring each feature map data in the j^{th} convolution window according to second addresses of the j^{th} convolution window in the S third dimensions and first addresses of each feature map data in the j^{th} convolution window in the R second dimensions.

Referring to FIG. 7, the first address combining circuit 72 may be connected to each address generating circuit in the first set of address generating circuits, to receive the address y generated by each address generating circuit in the first set of address generating circuits, and combine the received addresses y to obtain the first read addresses of each feature map data in the j^{th} convolution window. Each feature map data in the j^{th} convolution window may, for example, be stored in the first memory 621. After the first read addresses of each feature map data in the j^{th} convolution window is combined, the first storage device 62 may read, according to the first read addresses, each feature map data in the j^{th} convolution window required for performing the j^{th} convolution from the first memory 621, and transmit each feature map data in the j^{th} convolution window to the compute unit 61, such that the compute unit 61 performs the j^{th} convolution.

In some embodiments, the first address combining circuit 72 may accumulate the first addresses of each feature map data in the j^{th} convolution window in the R second dimensions and the second addresses of the j^{th} convolution window in the S third dimensions, to obtain the first read addresses of the feature map data. In these embodiments, different feature map data in the same convolution window have different first read addresses.

It is to be understood that for different convolutions, the number of the R first address generating circuits 711 may be different, and the number of the S second address generating circuits 712 may also be different. For example, each convolution window of a plurality of convolution windows required for performing one convolution is a 3-dimension matrix, and the plurality of convolution windows are distributed along two second dimensions, such that S=2 and R=3; and for another example, each convolution window of a plurality of convolution windows required for performing another convolution is a 3-dimension matrix, and the plurality of convolution windows are distributed along three second dimensions, such that S=3 and R=3.

In the above embodiment, for the j^{th} convolution, the S second address generating circuits 712 generate, according to the function y-floor(ax+b)×T, the second addresses for uniquely determining the j^{th} convolution window required for performing the j^{th} computation, the R first address generating circuits 711 generate, according to the function y-floor(ax+b)×T, the first addresses for uniquely determining each feature map data in the j^{th} convolution window, such that the first address combining circuit 72 combines the second addresses of the j^{th} convolution window in the S third dimensions and the first addresses of each feature map data in the j^{th} convolution window in the R second dimensions to obtain the first read addresses for acquiring each feature map data required for performing the j^{th} convolution. Accordingly, the first address generator 623 can perform combination to obtain the first read addresses of each feature map data in different convolution windows required for different convolutions by adjusting values of a, b, and T corresponding to each first address generating circuit and each second address generating circuit in each convolution. Accordingly, universality of the first address generator 623 can be improved without increasing design complexity and size, improving universality of the first storage device 62 and then improving universality of the artificial intelligence chip 60.

Then, the manner of generating the second read addresses by the second address generator is described in combination with some embodiments.

In some embodiments, the second address generator 632 may include a second set of address generating circuits and a second address combining circuit.

The second set of address generating circuits may include R third address generating circuits.

It is to be understood that a distribution dimension of the convolution kernel data in the convolution kernel and a distribution dimension of the feature map data in the convolution window are both second dimensions. For one convolution kernel, because only the distribution dimension (i.e., the second dimension) of the convolution kernel data exists, the second set of address generating circuits may only include the R third address generating circuits.

It is to be further understood that in some situations, if a plurality of convolution kernels required for performing the convolution are distributed according to a certain rule, the second set of address generating circuits may further include other address generating circuits besides the R third address generating circuits.

The R third address generating circuits are in one-to-one correspondence with the R second dimensions. That is, an r^{th} third address generating circuit in the R third address generating circuits corresponds to the r^{th} second dimension in the R second dimensions, and 1≤r≤R.

The R second dimensions refer to the dimension of the convolution kernel data in the convolution kernel required for performing the j^{th} convolution, that is, the convolution kernel data in the convolution kernel is distributed along the R second dimensions, and the convolution kernel and the j^{th} convolution window are both R-dimension matrices.

The r^{th} third address generating circuit is configured to generate, according to the function yᵣ=floor(aᵣxᵣ+bᵣ)×Tᵣ, a third address yᵣ of each convolution kernel data in the r^{th} second dimension in the convolution kernel required for performing the j^{th} convolution, and 1≤r≤R. The convolution kernel data at different positions in the r^{th} second dimension corresponds to different values of xᵣ, and values of aᵣ, bᵣ, and Tᵣ are set to make different values of xᵣ correspond to different values of yᵣ.

For example, the 1st third address generating circuit is configured to generate, according to the function yᵣ₌₁=floor(aᵣ₌₁xᵣ₌₁+bᵣ₌₁)×Tᵣ₌₁, a third address yᵣ₌₁ of each convolution kernel data in the 1st second dimension in the convolution kernel required for performing the j^{th} convolution; the 2nd third address generating circuit is configured to generate, according to the function yᵣ₌₂=floor(aᵣ₌₂xᵣ₌₂+bᵣ₌₂)×Tᵣ₌₂, a third address yᵣ₌₂ of each convolution kernel data in the 2nd second dimension in the convolution kernel required for performing the j^{th} convolution; and so on.

It is to be understood that values of a, b, and T corresponding to the different third address generating circuits may be the same or different. When different convolutions are performed, values of a, b, and T corresponding to the same third address generating circuit may be the same or different.

It is to be further understood that based on R third addresses of any convolution kernel data in the R second dimensions, the convolution kernel data may be uniquely determined in the convolution kernel where the convolution kernel data is located.

The second address combining circuit is configured to generate second read addresses for acquiring each convolution kernel data in the convolution kernel according to third addresses of each convolution kernel data in the R second dimensions in the convolution kernel.

For example, the second address combining circuit may be connected to each third address generating circuit in the second set of address generating circuits, to receive the address y generated by each third address generating circuit, and combine the received addresses y to obtain the second read addresses of each convolution kernel data in the convolution kernel required for performing the j^{th} convolution. Each convolution kernel data in the convolution kernel required for performing the j^{th} convolution may, for example, be stored in the second memory 631. After the second read addresses of each convolution kernel data in the convolution kernel are combined, the second storage device 63 may read, according to the second read addresses, each convolution kernel data in the convolution kernel required for performing the j^{th} convolution from the second memory 631, and transmit each convolution kernel data in the convolution kernel to the compute unit 61, such that the compute unit 61 performs the j^{th} convolution.

In some embodiments, the second address combining circuit may accumulate the third addresses of each convolution kernel data in the convolution kernel in the R second dimensions, to obtain the second read addresses of the convolution kernel data. In these embodiments, the different convolution kernel data in the convolution kernel have different second read addresses.

It is to be understood that for different convolutions, the number of the R third address generating circuits may be different. For example, a convolution kernel required for performing one convolution is a 3-dimension matrix, such that R=3; and for another example, a convolution kernel required for performing another convolution is a 4-dimension matrix, such that R=4.

In the above embodiment, for the j^{th} convolution, the R third address generating circuits may generate, according to the function y=floor(ax+b)×T, the third addresses for uniquely determining each convolution kernel data in the convolution kernel, such that the second address combining circuit combines the third addresses of each convolution kernel data in the convolution kernel in the R second dimensions to obtain the second read addresses for acquiring each convolution kernel data required for performing the j^{th} convolution.

Accordingly, the second address generator 632 can perform combination to obtain the second read addresses for acquiring each convolution kernel data required for different convolutions by adjusting values of a, b, and T corresponding to each third address generating circuit in each convolution. Accordingly, universality of the second address generator 632 can be improved without increasing design complexity and size, improving universality of the second storage device 63 and then further improving universality of the artificial intelligence chip 60.

According to yet another aspect of this embodiment of the present disclosure, a streaming-based compute method is provided.

The streaming-based compute method includes: N convolutions are performed on N convolution windows and a corresponding convolution kernel through a streaming-based compute unit.

A j^{th} convolution includes performing M multiplication operations on M feature map data in a j^{th} convolution window and M convolution kernel data in a convolution kernel, to obtain M first computation results. The N convolutions include N multiplication operations sequentially and consecutively performed on at least one set of feature map data and at least one M convolution kernel data. Each set of feature map data includes N feature map data corresponding to the N convolution windows at the same position, N≥2, M≥2, and 1≤j≤N.

A j^{th} register in N registers of the streaming-based compute unit stores a second computation result of the j^{th} convolution window. After an i^{th} multiplication operation in the M multiplication operations in the j^{th} convolution, the second computation result is updated into a sum of i first computation results of the first i multiplication operations in the M multiplication operations in the j^{th} convolution, and 1≤i≤M.

In some embodiments, the N convolutions include a plurality of groups of multiplication operations performed on a plurality of sets of feature map data and a plurality of convolution kernel data in the M convolution kernel data, and the plurality of sets of feature map data are in one-to-one correspondence with the plurality of convolution kernel data. Each of the plurality of groups of multiplication operations includes N multiplication operations sequentially and consecutively performed on one set of feature map data and one corresponding convolution kernel data. Different sets of feature map data correspond to different positions of the N convolution windows.

It is to be understood that the streaming-based compute unit may be the compute unit (e.g., the compute unit 20) of any above embodiment. Other embodiments and advantages of the streaming-based compute method provided by this embodiment of the present disclosure may be referred to the descriptions of the streaming-based compute unit according to the foregoing embodiments of the present disclosure, which are not described in detail herein.

An embodiment of the present disclosure further provides an accelerator, including the artificial intelligence chip (e.g., the artificial intelligence chip 60) of any above embodiment.

Thus, the various embodiments of the present disclosure have been described in detail. In order to avoid obscuring the concept of the present disclosure, some known details in the art are not described. Those skilled in the art can fully understand, according to the above descriptions, how to implement the technical solutions disclosed herein.

Although some specific embodiments of the present disclosure have been described in detail through the examples, those skilled in the art should understand that the above examples are merely for the descriptive purpose rather than limit the scope of the present disclosure. Those skilled in the art should understand that the above embodiments may be modified or part of technical features may be equivalently substituted without departing from the scope and the spirit of the present disclosure. The scope of the present disclosure is limited by the attached claims.

What is claimed is:

1. A streaming-based compute unit, comprising N registers, N≥2, wherein
the compute unit is configured to perform N convolutions on N convolution windows and a corresponding convolution kernel, wherein a j^{th} convolution comprises performing M multiplication operations on M feature map data in a j^{th} convolution window and M convolution kernel data in the convolution kernel to obtain M first computation results, the N convolutions comprise N multiplication operations sequentially and consecutively performed on at least one set of feature map data and at least one corresponding convolution kernel data in the M convolution kernel data, each set of feature map data comprises N feature map data at a same position corresponding to the N convolution windows, M≥2, and 1≤j≤N; and
a j^{th} register is configured to store a second computation result of the j^{th} convolution window, wherein after an i^{th} multiplication operation in the M multiplication operations in the j^{th} convolution, the second computation result is updated into a sum of i first computation results of the first i multiplication operations in the M multiplication operations in the j^{th} convolution, and 1≤i≤M.

2. The streaming-based compute unit according to claim 1, wherein
the N convolutions comprise a plurality of groups of multiplication operations performed on a plurality of sets of feature map data and a plurality of corresponding convolution kernel data in the M convolution kernel data, and the plurality of sets of feature map data are in one-to-one correspondence with the plurality of convolution kernel data;
each of the plurality of groups of multiplication operations comprises N multiplication operations sequentially and consecutively performed on one set of feature map data and one corresponding convolution kernel data; and
different sets of feature map data correspond to different positions of the N convolution windows.

3. The streaming-based compute unit according to claim 2, wherein the plurality of sets of feature map data comprise M sets of feature map data, and the plurality of convolution kernel data comprise the M convolution kernel data.

4. The streaming-based compute unit according to claim 1, further comprising:
an accumulator, configured to accumulate, after the i^{th} multiplication operation in the M multiplication operations in the j^{th} convolution, i−1 first computation results of the first i−1 multiplication operations and a first computation result of the i^{th} multiplication operation in the M multiplication operations in the j^{th} convolution, to obtain the second computation result of the j^{th} convolution window; and
a first demutiplexer, configured to transmit the second computation result of the j^{th} convolution window to the j^{th} register after the i^{th} multiplication operation in the M multiplication operations in the j^{th} convolution.

5. The streaming-based compute unit according to claim 4, further comprising:
a multiplexer, configured to acquire a sum of the i−1 first computation results of the first i−1 multiplication operations from the j^{th} register after the i^{th} multiplication operation in the M multiplication operations in the j^{th} convolution; and
a second demutiplexer, configured to transmit the sum of the i−1 first computation results of the first i−1 multiplication operations from the multiplexer to the accumulator.

6. The streaming-based compute unit according to claim 5, wherein each feature map data comprises feature map sub-data of C channels, each convolution kernel data comprises weight data of C channels, C≥1, and the compute unit further comprises:
P multipliers, each configured to multiply feature map sub-data and weight data of a corresponding channel in the i^{th} multiplication operation in the M multiplication operations in the j^{th} convolution, to obtain a third computation result, wherein the P multipliers are in one-to-one correspondence with P channels, and 1≤P≤C; and
the accumulator is further configured to accumulate C third computation results in the i^{th} multiplication operation in the M multiplication operations in the j^{th} convolution, to obtain the first computation result of the i^{th} multiplication operation.

7. The streaming-based compute unit according to claim 6, wherein C≥2, and the accumulator comprises:
a first accumulator, configured to accumulate the C third computation results in the i^{th} multiplication operation in the M multiplication operations in the j^{th} convolution, to obtain the first computation result of the i^{th} multiplication operation; and
a second accumulator, configured to accumulate the i−1 first computation results of the first i−1 multiplication operations in the M multiplication operations in the j^{th} convolution from the second demutiplexer and the first computation result of the i^{th} multiplication operation from the first accumulator, to obtain the second computation result of the j^{th} convolution window.

8. The streaming-based compute unit according to claim 7, wherein P>2, and the first accumulator comprises:
at least one third accumulator, each configured to accumulate two third computation results of two multipliers, to obtain a fourth computation result; and
a fourth accumulator, configured to accumulate the fourth computation result of each third accumulator in the i^{th} multiplication operation in the M multiplication operations in the j^{th} convolution, to obtain the first computation result of the i^{th} multiplication operation.

9. The streaming-based compute unit according to claim 1, wherein
an input feature map to be computed comprises W convolution windows distributed in a first dimension, the W convolution windows comprise [W/N] sets of convolution windows, and each set of the convolution windows comprises N convolution windows; and
the compute unit is further configured to perform [W/N] computations, each computation comprises performing the N convolutions on one set of convolution windows and the convolution kernel, and
in a case that a remainder D of W/N is not equal to 0, perform, in response to an instruction signal, D convolutions on D convolution windows other than the [W/N] sets of convolution windows in the W convolution windows and the convolution kernel after the [W/N] computations are performed.

10. The streaming-based compute unit according to claim 9, wherein D≥2, the D convolutions comprise D multiplication operations sequentially and consecutively performed on the at least one set of feature map data and at least one convolution kernel data in the M convolution kernel data, and each set of feature map data corresponding to the D convolutions comprises D feature map data at a same position corresponding to the D convolution windows.

11. An artificial intelligence chip, comprising:
the compute unit according to claim 1;
a first storage device, comprising a first memory, wherein the first memory is configured to store M feature map data of each convolution window of N convolution windows, the first storage device is configured to receive first read addresses corresponding to a j^{th} convolution, read, according to the first read addresses, each feature map data in a j^{th} convolution window required for performing a j^{th} convolution from the first memory, and transmit each feature map data in the j^{th} convolution window to the compute unit, wherein at least one set of feature map data is sequentially and consecutively read and transmitted to the compute unit; and
a second storage device, comprising a second memory, wherein the second memory is configured to store M convolution kernel data in a convolution kernel, the second storage device is configured to receive second read addresses corresponding to the j^{th} convolution, read, according to the second read addresses, each convolution kernel data in the convolution kernel from the second memory, and transmit each convolution kernel data in the convolution kernel to the compute unit, wherein each convolution kernel data of the at least one convolution kernel data is obtained by performing one read operation on the second memory.

12. The artificial intelligence chip according to claim 11, wherein an input feature map to be computed comprises W convolution windows distributed in a first dimension, the W convolution windows comprise [W/N] sets of convolution windows, and each set of convolution windows comprises N convolution windows;
the first storage device further comprises a data processing circuit configured to send an instruction signal to the compute unit in a case that a remainder D of W/N is not equal to 0; and
the compute unit is further configured to perform [W/N] computations, wherein each computation comprises performing the N convolutions on one set of convolution windows and the convolution kernel, and
in response to the instruction signal, D convolutions are performed on D convolution windows other than the [W/N] sets of convolution windows in the W convolution windows and the convolution kernel after the [W/N] computations are performed.

13. The artificial intelligence chip according to claim 11, wherein the first storage device further comprises:
a first control register, configured to send a first drive signal in response to a first configuration signal corresponding to the j^{th} convolution; and
a first address generator, configured to generate the first read addresses in response to the first drive signal from the first control register.

14. The artificial intelligence chip according to claim 11, wherein the second storage device further comprises:
a second control register, configured to send a second drive signal in response to a second configuration signal corresponding to the j^{th} convolution; and
a second address generator, configured to generate the second read addresses in response to the second drive signal from the second control register.

15. The artificial intelligence chip according to claim 13, wherein the first address generator comprises:
a first set of address generating circuits, comprising:
R first address generating circuits, in one-to-one correspondence with R second dimensions, wherein an r^{th} first address generating circuit is configured to generate, according to a function yᵣ=floor(aᵣxᵣ+bᵣ)×Tᵣ, a first address yᵣ of each feature map data in an r^{th} second dimension in the j^{th} convolution window required for performing the j^{th} convolution, wherein 1≤r≤R, the feature map data at different positions in the r^{th} second dimension corresponds to different values of xᵣ, and values of aᵣ, bᵣ, and Tᵣ are set to make different values of xᵣ correspond to different values of yᵣ, and the N convolution windows are distributed in S third dimensions; and
S second address generating circuits, different from the R first address generating circuits and in one-to-one correspondence with the S third dimensions, wherein an s^{th} second address generating circuit is configured to generate, according to a function yₛ=floor(aₛxₛ+bₛ)×Tₛ, a second address yₛ of the j^{th} convolution window in an s^{th} third dimension, wherein 1≤s≤S, convolution windows at different positions in the s^{th} third dimension correspond to different values of xₛ, and values of aₛ, bₛ, and Tₛ are set to make different values of xₛ correspond to different values of yₛ; and
a first address combining circuit, configured to generate the first read addresses for acquiring each feature map data in the j^{th} convolution window according to second addresses of the j^{th} convolution window in the S third dimensions and first addresses of each feature map data in the j^{th} convolution window in the R second dimensions.

16. The artificial intelligence chip according to claim 14, wherein the second address generator comprises:
a second set of address generating circuits, comprising:
R third address generating circuits, in one-to-one correspondence with R second dimensions, wherein an r^{th} third address generating circuit is configured to generate, according to a function yᵣ=floor(aᵣxᵣ+bᵣ)×Tᵣ, a third address yᵣ of each convolution kernel data in an r^{th} second dimension in the convolution kernel required for performing the j^{th} convolution, wherein 1≤r≤R, the convolution kernel data at different positions in the r^{th} second dimension corresponds to different values of xᵣ, and values of aᵣ, bᵣ, and Tᵣ are set to make different values of xᵣ correspond to different values of yᵣ; and
a second address combining circuit, configured to generate the second read addresses for acquiring each convolution kernel data in the convolution kernel according to third addresses of each convolution kernel data in the R second dimensions in the convolution kernel.

17. A streaming-based compute method, comprising:
performing, by a streaming-based compute unit, N convolutions on N convolution windows and a corresponding convolution kernel, wherein a j^{th} convolution comprises performing M multiplication operations on M feature map data in a j^{th} convolution window and M convolution kernel data in the convolution kernel, to obtain M first computation results, the N convolutions comprise N multiplication operations sequentially and consecutively performed on at least one set of feature map data and at least one corresponding convolution kernel data in the M convolution kernel data, each set of feature map data comprises N feature map data corresponding to the N convolution windows at the same position, N≥2, M≥2, and 1≤j≤N; and
storing, by a j^{th} register in N registers of the compute unit, a second computation result of the j^{th} convolution window, wherein after an i^{th} multiplication operation in the M multiplication operations in the j^{th} convolution, the second computation result is updated into a sum of i first computation results of the first i multiplication operations in the M multiplication operations in the j^{th} convolution, and 1≤i≤M.

18. The streaming-based compute method according to claim 17, wherein
the N convolutions comprise a plurality of groups of multiplication operations performed on a plurality of sets of feature map data and a plurality of corresponding convolution kernel data in the M convolution kernel data, and the plurality of sets of feature map data are in one-to-one correspondence with the plurality of convolution kernel data;
each of the plurality of groups of multiplication operations comprises N multiplication operations sequentially and consecutively performed on one set of feature map data and one corresponding convolution kernel data; and
different sets of feature map data correspond to different positions of the N convolution windows.

19. The streaming-based compute method according to claim 17, further comprising:
accumulating, by an accumulator of the compute unit and after the i^{th} multiplication operation in the M multiplication operations in the j^{th} convolution, i−1 first computation results of the first i−1 multiplication operations and a first computation result of the i^{th} multiplication operation in the M multiplication operations in the j^{th} convolution, to obtain the second computation result of the j^{th} convolution window; and
transmitting, by a first demutiplexer of the compute unit, the second computation result of the j^{th} convolution window to the j^{th} register after the i^{th} multiplication operation in the M multiplication operations in the j^{th} convolution.

20. The streaming-based compute compute unit according to claim 19, further comprising:
acquiring, by a multiplexer of the compute unit, a sum of the i−1 first computation results of the first i−1 multiplication operations from the j^{th} register after the i^{th} multiplication operation in the M multiplication operations in the j^{th} convolution; and
transmitting, by a second demutiplexer of the compute unit, the sum of the i−1 first computation results of the first i−1 multiplication operations from the multiplexer to the accumulator.
